(19) United States
(12) Patent Application Publication
(10) Pub. No.: US 2008/0299370 A1
(43) Pub. Date: Dec. 4, 2008

(54) Multi-Layer Polyolefin Film

(75) Inventor: Dena Briggs, Greenfield, MA (US)

Correspondence Address: MCANDREWS HELD & MALLOY, LTD, 500 WEST MADISON STREET, SUITE 3400, CHICAGO, IL, 60661, US

(73) Assignee: Pliant Corporation

(21) Appl. No.: 11/630,193

(22) PCT Filed: Jun. 24, 2004
(86) PCT No.: PCT/US04/20137

§ 371 Date: Nov. 12, 2007

(51) Int. Cl. B32B 27/32; B32B 27/34

(52) U.S. Cl. 428/220; 428/516; 428/476.9

(57) ABSTRACT

A multi-layer film having skin layers of linear low density polyethylene, low density polyethylene and cycloolefin polymers. The film further includes a core layer of metallocene-catalyzed polyolefin polymers and/or polyamide polymers.

### TECHNICAL FIELD

The present invention relates to flexible food packaging. In particular, the present invention is directed to multi-layer films having skin layers of linear low density polyethylene, low density polyethylene and cycloolefin polymers, and a core layer of metallocene-catalyzed polyolefin polymers and/or polyamide polymers.

### BACKGROUND ART

Food packaging has undergone a recent trend toward switching from rigid to flexible packaging. That is, there has been a shift from rigid structures such as cans, bottles and boxes, to flexible packaging such as pouches, bags and films for several reasons. First, flexible packaging offers source reduction and weight savings over rigid packaging in most cases. This can provide significant cost savings for many packages. It also offers a differentiating presence on the shelf for retail items in, for example, stand-up pouches. There is also an advantage in that flexible packaging provides improved convenience due to the presence of zippers or fitted closures. Flexible packaging has particularly appeared in the frozen food section with whole meal kits, frozen poultry, and other protein products.

Flexible packaging for food generally performs several important functions. First, the packaging must protect the product from moisture, have a gas barrier if necessary, provide flavor/odor protection, and provide protection from light. Food packaging is also desirably convenient and portable. It should usually be suitable for product promotion such as graphics, shape and design, and other marketing needs. In addition to the functions described above, frozen food packaging, in particular, desirably possesses puncture resistance at low temperatures and balanced tear properties for easy opening of the packaging. Accordingly, there is a need in the art for flexible food packaging meeting the conditions described above. There is also a need in the art for commercially-feasible packaging that is not overly expensive in comparison to traditional rigid packaging or flexible laminated packaging.

### DISCLOSURE OF THE INVENTION

The film of the present invention includes a film structure having a first layer including a quantity of at least one polyolefin polymer and a quantity of a cycloolefin copolymer. A second layer is also provided wherein the second layer also includes a quantity of at least one polyolefin polymer and a quantity of a cycloolefin copolymer. Finally, a third layer is provided that includes a quantity of at least one polymer selected from the group consisting of metallocene-catalyzed polyolefin polymers, polyamide polymers, and mixtures thereof.

### BEST MODE FOR CARRYING OUT OF THE INVENTION

The film of the present invention has a structure that includes at least one first layer of a mixture of at least one polyolefin polymer and a cycloolefin polymer (“COP”). A second layer also includes a mixture of at least one polyolefin polymer and a COP. The film of the present invention also includes at least one third layer composed of at least one metallocene-catalyzed polyolefin polymer, at least one polyamide polymer, or a mixture thereof. In the preferred film, the first layer constitutes from about 5-30% by weight of the film structure, more preferably from about 10-20%, and most preferably about 15%. The preferred second layer also constitutes from about 5-30% by weight of the film structure, more preferably from about 10-20%, and most preferably about 15%. One skilled in the art will appreciate that the first and second layers described herein are preferably used as the outer or skin layers of the film structure of the present invention.

In the preferred at least one first layer and at least one second layer, the polyolefin polymer preferably constitutes from about 50-99% by weight of each layer, more preferably 60-90%, and most preferably about 75%. Preferred polyolefin polymers include polyethylene, polypropylene, polybutenes, polyisoprene, copolymers thereof terpolymers thereof, α-olefin propylene copolymers, and mixtures thereof. Suitable polyethylenes include, in particular, low density polyethylene (LDPE), linear low density polyethylene (LLDPE), ultra low density polyethylene (ULDPE), and ethylene acetyl acetate (EAA). Preferred propylene polymers generally contain from about 90-100% by weight of propylene units and the preferred propylene polymers generally have a melting point of 130° C. or above. Preferred propylene polymers generally have a melt flow index of from 0.5 g/10 min to 10 g/10 min at 230° C. and a force of 21.6 N. Isotactic propylene homopolymer having an n-heptane-soluble content of from about 1-15% by weight, copolymers of ethylene and propylene having an ethylene content of 10% by weight or less, copolymers of propylene with C₄-C₈ α-olefins having an α-olefin content of 10% by weight or less, and terpolymers of propylene, ethylene and butylene having an ethylene content of 10% by weight or less and a butylene content of 15% by weight or less are preferred propylene polymers. Also suitable is a mixture of propylene homopolymers, copolymers, terpolymers and other polyolefins.

In accordance with present invention, the COP component of the first and second layers constitutes from about 1-49% by weight of each layer, more preferably 10-40%, and most preferably about 25%. Cycloolefin polymers are homopolymers made from one kind of cycloolefin, or they may include copolymers made from cycloolefin polymers and comonomers (“COCs”) where the comonomer content may be up to about 20% by weight, based upon the weight of the cycloolefin polymer. As used herein, the term cycloolefin means alicyclic hydrocarbon having two or more double bonds such as cycloalkenes, bicycloalkenes, tricycloalkenes or tetracycloalkenes. Particularly preferred cycloolefins include cyclopentadiene, cyclohexadiene, and cyclooctatetetraene. The cycloolefin ring systems may be mono- or poly-substituted. Preferred cycloolefins are shown below as formulas I, II, III, IV, V, and VI wherein R¹, R², R³, R⁴, R⁵, R⁶, R⁷ and R⁸ may be different or identical and may be selected from the group consisting of a hydrogen atom, a C₆-C₂₀-aryl or C₁-C₂₀-alkyl radical or a halogen atom, or a monocyclic olefin of the formula VII wherein n=2-10.

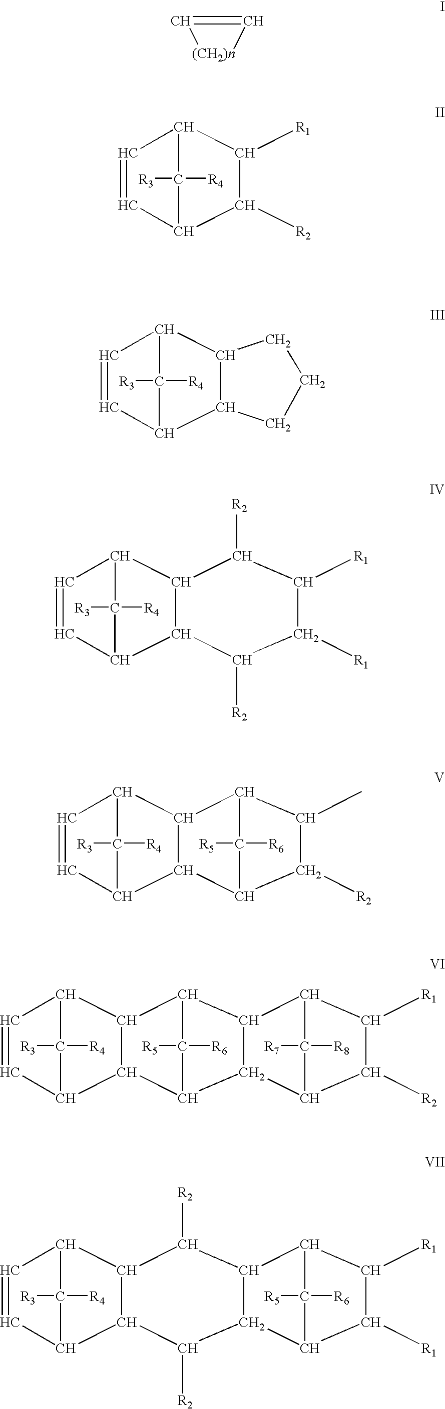

While any of the COPs described above may be used in accordance with the present invention, preferred COPs also include polynorbornene, polydimethyloctahydronapthalene, polycyclopentane, poly(5-methyl) norbomene, and mixtures thereof. The COPs may also be branched and can have comb or star structures. The cycloolefins described above may also be copolymerized with small amounts of comonomers. The resulting COCs preferably contain up to 20% by weight of comonomer based on the weight of the COC, more preferably 1-10%, and most preferably 1-8%. Particularly preferred comonomers are olefins having 2-6 carbon atoms and include ethylene and butylene. Particularly preferred commercially-available COCs include those made from ethylene and norbornene and sold under the trademark Topas® by Ticona Engineering Polymers.

The preferred third layer of the present invention constitutes from about 40-90% by weight of the film structure, more preferably from about 60-80%, and most preferably about 70%. The third layer is preferably an inner layer and may be a core layer depending upon the application intended. The third layer is preferably comprised of polyamide polymers, metallocene-catalyzed polyolefin polymers, and mixtures thereof. In a preferred embodiment, the third layer includes from about 1-100% by weight of the layer, more preferably from about 50-90%, and most preferably from about 65-75%, of at least one metallocene-catalyzed polyolefin polymer. Preferred metallocenes are single site catalysts and include dicyclopentadienyl-metals and -metal halides. A preferred polyolefin polymer is an ethylene-based polymer such as a hexene copolymer produced with metallocene single site catalysts. Most preferred is metallocene linear low density polyethylene (mLLDPE). The preferred mLLDPE has a melt index of about 1.0 g/10 min, a density of about 0.918 g/cm³, and a peak melting temperature of 118° C. such as that sold under the trademark Exceed ® by ExxonMobil Chemical (Houston, Tex.). In a second preferred embodiment, the third layer includes from about 1-100% by weight of the layer, more preferably from about 40-80%, and most preferably from about 50-75%, of at least one polyamide polymer. Preferred polyamide polymers include nylon 6 and nylon 6/6 such as those sold under the trademark Zytel® by DuPont Corporation (Wilmington, Del.) and the trademark Capron® by Honeywell, Inc. formerly Allied Signal Corporation (Morristown, N.J.). Mixtures thereof may also be used to form the third layer.

In the first and second embodiments of the film of the present invention described hereinabove, the film structure is a three-layer structure with the first and second layers preferably being outer layers and the third layer preferably being a core or inner layer. It will be appreciated by those skilled in the art that additional layers could be added to the film to form a 5, 7, 9 or more layered film. In addition to the first, second, and third layers described above, at least one additional layer composed of at least one polyolefin polymer may also be included in the film of the present invention. No COPs or COCs are present in this layer. Preferred polyolefin polymers include all those described above in connection with the first and second layers.

It will be appreciated by those skilled in the art that additives may be added to one or more layers of the film of the present invention in order to improve certain characteristics of the particular layer. Preferred additives include color concentrates, neutralizers, process aids, lubricants, stabilizers, hydrocarbon resins, antistatics, slip agents and antiblocking agents. From about 0-99% by weight of an individual layer, more preferably from about 20-40%, and most preferably from about 24-35%, of a color concentrate may be added to the layer to yield a colored layer, an opaque layer, or a translucent layer. Preferred color concentrates include color formulations including black, white, and other colors suitable for blown films such as those manufactured by Ampacet Corporation (Tarrytown, N.Y.). Preferred color concentrates include Ampacet® white PE masterbatch, the carrier resin of which being a LLDPE having a melt index of 20 g/10 min and a density of 0.92 gm/cc and the concentrate of which has a nominal specific gravity of 2.06, a melt index of 3-23 g/10 min and nominally contains 75% ash. Another preferred color concentrate includes Ampacet® white HDPE masterbatch, the carrier resin of which being a HD/LLDPE having a nominal melt index of 10 g/10 min and a density of 0.96 gm/cc. The concentrate has a nominal specific gravity of 1.54, a melt index of 9-15 g/10 min, and a pigment composed of 50% TiO₂.

Suitable neutralizers include calcium carbonate and calcium stearate. Such neutralizers are preferably added to a layer in an amount from about 0.02-0.1% by weight of the layer. Preferred neutralizers have an absolute particle size of less than 10 μm and a specific surface area of at least 40 m²/g. Polymeric processing aids may also be used in a layer in an amount from about 0.02-3.0% by weight of the layer. Fluoropolymers, fluoropolymer blends, and fluoroelastomers are particularly preferred, but any processing aid known in the art for use in polymer films would be suitable. A particularly preferred processing aid is Ampacet® Process Aid PE masterbatch having a LLDPE carrier resin with a nominal melt index of 2 g/10 min and a density of0.918 gm/cc. The concentrate therein has a nominal specific gravity of 0.91, a nominal melt index of 1-3 g/10 min, and contains 3% ash.

Lubricants that may used in accordance with the present invention include higher aliphatic acid esters, higher aliphatic acid amides, metal soaps, polydimethylsiloxanes, and waxes. The preferred lubricants are preferably added to a layer in an amount from about 0.1-3% by weight of the layer. Conventional stabilizing compounds for polymers of ethylene, propylene, and other α-olefins are preferably employed in the present invention. The stabilizers may be added to a layer in an amount from about 0.05-2% by weight of the layer. In particular, alkali metal carbonates, alkaline earth metal carbonates, phenolic stabilizers, alkali metal stearates, and alkaline earth metal stearates are preferentially used as stabilizers for the composition of the present invention.

Hydrocarbon resins and, in particular, styrene resins, terpene resins, petroleum resins, and cyclopentadiene resins have been found to be suitable as additives in order to improve desirable physical properties of the film. These properties may include water vapor permeability, shrinkage, film rigidity and optical properties. In particular, adhesive resins are preferred. The preferred resin or resins may be added to a layer in an amount from about 1-30% by weight of the layer. A particularly preferred adhesive resin is sold under the trademark Bynel® by DuPont Corporation and is primarily composed of maleic anhydride modified polyolefin with some residual maleic anhydride and may also contain small amounts of stabilizers, additives and pigments.

Antistatics may be added to a layer in an amount from about 0.05-0.3% by weight of the layer. Preferred antistatics include substantially straight-chain and saturated aliphatic, tertiary amines containing an aliphatic radical having 10-20 carbon atoms that are substituted by ω-hydroxy-(C₁-C₄)-alkyl groups, and N,N-bis-(2-hydroxyethyl)alkylamines having 10-20 carbon atoms in the alkyl radical. Other suitable antistatics include ethyoxylated or propopylated polydiorganosiloxanes such as polydialkysiloxanes and polyalkylphenylsiloxanes, and alkali metal alkanesulfonates.

Slip agents may be added to a layer in an amount from about 0.02-3.0% by weight of the layer. Preferred slip agents include stearamide, oleamide, and erucamide. A particularly preferred slip agent is Ampacet® Slip PE masterbatch having a LDPE carrier resin with an 8 g/10 min melt index and a density of 0.918 gm/cc. The slip agent's concentrate has a nominal specific gravity of 0.92, anominal melt index of 10-16 g/10 min and contains 5% erucamide. Slip agents may be used alone or in combination with antiblocking agents in an amount from about 0.02-2.0% by weight of the layer. A particularly preferred slip/antiblock combination agents are sold by Ingenia Polymers (Toronto, Ontario) and include LLDPE erucamide/DE blends and oleamide/calcium carbonate blends.

From about 1.0-12.0% by weight of an antiblocking agent alone may also be added to a layer wherein the weight percent is based upon the total weight of the layer. Preferred antiblocking agents include organic polymers such as polyamides, polycarbonates, polyesters. Other preferred agents include calcium carbonate, aluminum silicate, magnesium silicate, calcium phosphate, silicon dioxide, and diatomaceous earth.

The total thickness of the film may vary and depends on the intended application for the film. The preferred film has a total thickness up to about 10 mils and, more preferably, from about 2.7-5.5 mils. The thickness of each separate inner layer is preferably from about 0.1-7.0 mils, more preferably from about 0.2-3.0 mils, and most preferably from about 2.0-3.0 mils. The preferred thickness of each outer layer is not dependent upon the thickness of any inner layer(s) and is preferably from about 0.3-5.0 mils, more preferably from about 0.3-3.0 mils, and most preferably from about 0.4-1.5 mils. It will be appreciated by those skilled in the art that the thickness of each inner layer and each outer layer may be similar or different in addition to having similar or different compositions. The thickness of each layer is therefore independent and may vary within the parameters set by the total thickness of the film. While the film of the present invention may be a cast film or other type of film, it is preferred that the film be a blown film.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

A three-layer film having a total film thickness of 2.6 mils was produced using the formula set forth in Table 1.

TABLE 1
Formulation 1-3 Layer Film Formulation

| Layer | Ratio | Cell | % bw | Type | ID | Mfr | Density | MI |
|---|---|---|---|---|---|---|---|---|
| A | 15% | A-1 | 20.0 | LDPE | NA-963 | Equistar | 0.919 | 0.70 |
| | | A-2 | 55.0 | LLDPE | 7109 | Chevron | 0.918 | 0.90 |
| | | A-3 | 25.0 | COC | 8007 | Ticona | 1.020 | 56.00 |
| B | 70% | B-1 | 72.0 | mLLDPE | 1018CA | Exxon | 0.918 | 1.00 |
| | | B-2 | 13.0 | White MB | 110313B | Ampacet | 2.030 | |
| | | B-3 | 15.0 | Repel | White | | 1.000 | |
| C | 15% | C-1 | 36.0 | LLDPE | 2077.01G | Dow | 0.922 | 0.85 |
| | | C-2 | 35.0 | POP* | PF1140G | Dow | 0.900 | 1.20 |
| | | C-3 | 4.0 | SLIP & AB† | 1070 | Ingenia | 0.970 | |
| | | C-4 | 25.0 | COC | 8007 | Ticona | 1.020 | 56.00 |

*POP = polyolefin plastomer
†SLIP = Slip Additive (400 ppm); AB = Antiblock Additive (ppm)

### EXAMPLE 2

A second substantially white three-layer film having a total film density of 3.00 mils was produced using the formula set forth in Table 2.

TABLE 2
Formulation 2-3 Layer Film Formulation

| Layer | Ratio | Cell | % bw | Type | ID | Mfr | Density | MI |
|---|---|---|---|---|---|---|---|---|
| A | 15% | A-1 | 20.0 | LDPE | 1031 | Huntsman | 0.919 | 0.8 |
| | | A-2 | 55.0 | LLDPE | 7109 | Chevron | 0.92 | 0.9 |
| | | A-3 | 25.0 | COC | 8007 | Ticona | 1.02 | 30.0 |
| B | 70% | B-1 | 85.0 | mLLDPE | 1018CA | Exxon | 0.918 | ? |
| | | B-2 | 14.0 | White MB | 111017 | Ampacet | 1.8 | 10.0 |
| | | B-3 | 1.0 | Processing | 10919 | Ampacet | 0.911 | 2.0 |
| | | | | Aid | | | | |
| C | 15% | C-1 | 36.0 | LLDPE | 2077.01G | Dow | 0.922 | 0.85 |
| | | C-2 | 36.0 | POP | PF1140G | Dow | 0.918 | |
| | | C-3 | 3.0 | SLIP & AB | 1070 | Ingenia | 0.970 | |
| | | C-4 | 25.0 | COC | 8007 | Ticona | 1.020 | 30.0 |

### EXAMPLE 3

A substantially white three-layer film having a total film density of 3.00 mils was produced using the formula set forth in Table 3.

TABLE 3
Formulation 3-3 Layer Film Formulation

| Layer | Ratio | Cell | % bw | Type | ID | Mfr | Density | MI |
|---|---|---|---|---|---|---|---|---|
| A | 15% | A-1 | 18.0 | LDPE | LD105.30 | Exxon | 0.919 | 2.06 |
| | | A-2 | 53.5 | LLDPE | 7109 | Chevron | 0.92 | 0.9 |
| | | A-3 | 25.0 | COC | 8007 | Ticona | 1.02 | 30.0 |
| | | A-4 | 2.0 | Slip Additive | 10090 | Ampacet | 0.915 | 5.0 |
| | | A-5 | 1.5 | Processing | 10919 | Ampacet | 0.911 | 2.0 |
| | | | | Aid | | | | |
| B | 70% | B-1 | 85.0 | mLLDPE | 1018CA | Exxon | 0.918 | 1.0 |
| | | B-2 | 14.0 | White MB | 111017 | Ampacet | 1.8 | 10.0 |
| | | B-3 | 1.0 | Processing | 10919 | Ampacet | 0.911 | 2.0 |
| | | | | Aid | | | | |
| C | 15% | C-1 | 36.0 | LLDPE | 2077.01G | Dow | 0.922 | 0.85 |
| | | C-2 | 36.0 | POP | PF1140 | Dow | 0.918 | 1.6 |
| | | C-3 | 3.0 | SLIP & AB | 1070 | Ingenia | 0.970 | |
| | | C-4 | 25.0 | COC | 8007 | Ticona | 1.02 | 30.0 |

### EXAMPLE 4

A substantially white five-layer film having a total film density of 3.00 mils was produced using the formula set forth in Table 4.

TABLE 4
Formulation 4-5 Layer Film Formulation

| Layer | Ratio | Cell | % bw | Type | ID | Mfr | Density | MI |
|---|---|---|---|---|---|---|---|---|
| A | 20.0% | A-1 | 63.0 | LLDPE | 7109 | Chevron | 0.92 | 0.9 |
| | | A-2 | 17.0 | White MB | 11233 | Ampacet | 1.8 | 13.5 |
| | | A-3 | 20.0 | COC | 8007 | Ticona | 1.02 | 30.0 |
| B | 15.0% | B-1 | 12.0 | Adhesive | 41E710 | DuPont | 0.918 | 2.7 |
| | | | | Resin | | | | |
| | | B-2 | 88.0 | mLLDPE | 1018CA | Exxon | 0.918 | 1 |
| C | 10.0% | C-1 | 100.0 | Nylon 6 | B135QP | Allied | 1.135 | 1.2 |
| D | 20.0% | D-1 | 12.0 | Adhesive | 41E710 | DuPont | 0.918 | 2.7 |
| | | | | Resin | | | | |
| | | D-2 | 88.0 | ULDPE | 4201G | Dow | 0.912 | 1.0 |
| E | 35.0% | E-1 | 35.0 | LLDPE | 2045G | Dow | 0.919 | 1.0 |
| | | E-2 | 46.0 | POP | PF1140 | Dow | 0.895 | 1.6 |
| | | E-3 | 4.0 | SLIP & AB | 1070 | Ingenia | 1.7 | |
| | | E-4 | 15.0 | COC | 8007 | Ticona | 1.02 | 30.0 |

### EXAMPLE 5

The films produced using Formulations 1, 2 and 3 described above in Examples 1, 2 and 3, respectively, were made into flexible bags and tested for case drop, 4′ ambient bag drop, 5′ freezer bag drop, shake test, and tear open failures. The results of such tests are shown in Table 5.

TABLE 5
Film Test Results

| | Case Drop | | Ambient Drop | | Freezer Drop | | Shake Test | | | | | | |
|---|---|---|---|---|---|---|---|---|---|---|---|---|---|
| | % | # | % | # | % | # | % | # | Tear Open Failures (%) | | | | |
| Formulation # | Failures | Tested | Failures | Tested | Failures | Tested | Failures | Tested | >1″ | >3″ | 2-3″ | 1-2″ | <1″ |
| 1 | 2.2 | 90 | 0 | 100 | 22 | 100 | 2.8 | 36 | 35 | 34 | 1 | 0 | 0 |
| 2 | 15.6 | 90 | 2 | 100 | 36 | 100 | 0 | 36 | 0 | 0 | 0 | 0 | 0 |
| 3 | | | | 100 | 19 | 100 | 90.6 | 32 | 0 | 0 | 0 | 0 | 0 |

### COMPARATIVE EXAMPLE 1

The physical properties of Formulations 1, 2 and 3 were determined in addition the physical properties of a control film, namely, a biaxially-oriented polypropylene film laminated to machine-direction oriented nylon coextruded film with 2 layers of nylon and white. The results are shown below in Table 7.

TABLE 7
Physical Properties Test Results.

| Property | ASTM Test # | Units | Control Film | Formulation 1 | Formulation 2 | Formulation 3 |
|---|---|---|---|---|---|---|
| Gauge | D 2103 | Mils | 2.89 | 2.87 | 2.99 | 3.03 |
| Light Transmission | D 1003 | % | 17.7 | 34.8 | 35.2 | 31.0 |
| Dart Drop | D 1709 | Grams | >515 | | >515 | >515 |
| M.D. Strip/Gauge | D 2103 | Mils | 2.85 | 3.0 | 3.11 | 3.07 |
| M.D. Tensile @ Break | D 882 | Psi | 13632 | 3635 | 4538 | 4814 |
| M.D. Elongation | D 882 | % | 96 | 359 | 310 | 354 |
| M.S. Yield | D 882 | Psi | 2542 | 1841 | 2979 | 2743 |
| M.D. Elongation @ | D 882 | % | 3 | 8 | 9 | 8 |
| Yield | | | | | | |
| M.D. Secant Modulus | D 882 | Psi | 79982 | 54403 | 53796 | 55924 |
| M.D. Elmendorf Tear | D 1922 | Grams | 1009 | | 635 | 589 |
| T.D. Strip/Gauge | D 2103 | Mils | 2.92 | 2.81 | 2.72 | 3.08 |
| T.D. Tensile @ Break | D 882 | Psi | 10946 | 4513 | 5868 | 6461 |
| T.D. Elongation | D 882 | % | 45 | 527 | 547 | 539 |
| T.D. Yield | D 882 | Psi | 2552 | 1759 | 2404 | 2709 |
| T.D. Elongation @ Yield | D 882 | % | 2 | 10 | 10 | 10 |
| T.D. Elmendorf Tear | D 1922 | Grams | 2157 | | 511 | 480 |
| T.D. Secant Modulus | D 882 | Psi | 79982 | 51944 | 52917 | 55151 |
| C.O.F. (inside/inside) | D 1894 | | 0.19 | 0.23 | 0.16 | 0.16 |
| C.O.F. (outside/outside) | D 1894 | | 0.25 | 0.69 | 0.13 | 0.57 |
| M.D. Gurley | D 6125 | Mg | 6.741 | 9.41 | | |
| T.D. Gurley | D 6125 | Mg | 7.367 | 9.92 | | |

As demonstrated by these results, the secant modulus of the three film formulations of the present invention is 50,000 psi or greater in both the transverse (TD) and machine (MD) directions. Moreover, the film of the present invention has balanced tear properties so that it is not substantially easier to tear the film in one direction as compared to the other. Further, the high secant modulus for the film of the present invention is important because, unlike conventional films, the film of the present invention does not contain high density polyethylene or some other crystalline material. In comparison, the control film has a much higher TD tear than MD tear indicating that the film will tend to tear in the wrong direction during package opening.

The foregoing description of the embodiments of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and modifications as are suited to the particular use contemplated. It is intended that the scope of the invention not be limited by the specification, but be defined by the claims set forth below.

We claim:

1. A film structure comprising:
a first layer comprising a quantity of at least one polyolefin polymer and a quantity of a cycloolefin polymer;
a second layer comprising a quantity of at least one polyolefin polymer and a quantity of a cycloolefin polymer; and
a third layer comprising a quantity of at least one polymer selected from the group consisting of metallocene-catalyzed polyolefin polymers, polyamide polymers, and mixtures thereof.

2. The film structure of claim 1 wherein said first layer comprises from about 5-30% by weight of said film structure.

3. The film structure of claim 1 wherein said second layer comprises from about 5-30% by weight of said film structure.

4. The film structure of claim 2 wherein said first layer comprises about 15% by weight of said film structure.

5. The film structure of claim 3 wherein said second layer comprises about 15% by weight of said film structure.

6. The film structure of claim 5 wherein said third layer comprises from about 60-90% by weight of said film structure.

7. The film structure of claim 6 wherein said third layer comprises about 70% by weight of said film structure.

8. The film structure of claim 1 wherein said polyolefin polymer comprises from about 50-99% by weight of said first layer.

9. The film structure of claim 8 wherein said polyolefin polymer comprises about 75% by weight of said first layer.

10. The film structure of claim 1 wherein said polyolefin polymer comprises from about 60-90% by weight of said second layer.

11. The film structure of claim 10 wherein said polyolefin polymer comprises about 75% by weight of said second layer.

12. The film structure of claim 1 wherein said polymer comprises from about 1-100% by weight of said third layer.

13. The film structure of claim 12 wherein said polymer comprises from about 50-90% by weight of said third layer.

14. The film structure of claim 1 wherein said polyolefin polymer is selected from the group consisting of polyethylene, polypropylene, polybutenes, polyisoprene, copolymers thereof, terpolymers thereof, α-olefin propylene copolymers, and mixtures thereof.

15. The film structure of claim 14 wherein said polyolefin polymer is selected from the group consisting of linear low density polyethylene, low density polyethylene, ultra low density polyethylene, ethylene acetyl acetate, and mixtures thereof.

16. The film structure of claim 1 wherein said cycloolefin polymer is selected from the group consisting of cyclopentadiene, cyclohexadiene, cyclooctatetetraene, polynorbornene, polydimethyloctahydronaphthalene, cyclopentene, poly(5-methyl) norbornene, and mixtures thereof.

17. The film structure of claim 1 wherein said metallocene-catalyzed polyolefin polymer is metallocene linear low density polyethylene.

18. The film structure of claim 1 wherein said polyamide polymer is a nylon compound.

19. The film structure of claim 1 wherein said film structure has a thickness of up to 10 mils.

20. The film structure of claim 19 wherein said film structure has a thickness of from about 2.7-5.5 mils.

21. The film structure of claim 1 wherein said film structure is a blown film structure.

22. The film structure of claim 1 wherein said third layer is disposed between said first layer and said second layer.

23. The film structure of claim 22 further comprising a plurality of additional layers disposed between said first layer and said second layer.

24. The film structure of claim 23 wherein said additional layers comprises at least one layer comprising from about 70-100% by weight of a polyolefin polymer.

25. The film structure of claim 24 wherein said polyolefin polymer is selected from the group consisting of polyethylene, polypropylene, polybutenes, polyisoprene, copolymers thereof, terpolymers thereof, α-olefin propylene copolymers, and mixtures thereof.

26. The film structure of claim 25 wherein said polyolefin polymer is selected from the group consisting of linear low density polyethylene, low density polyethylene, ultra low density polyethylene, ethylene acetyl acetate, and mixtures thereof.

27. The film structure of claim 23 wherein said third layer comprises a metallocene-catalyzed polyolefin polymer and said additional layers comprise at least one layer comprising a polyamide polymer.

28. The film structure of claim 27 wherein said metallocene-catalyzed polyolefin polymer is metallocene linear low density polyethylene and said polyamide polymer is a nylon compound.

29. The film structure of claim 23 wherein said third layer comprises a polyamide polymer and said additional layers comprise at least one layer comprising a metallocene-catalyzed polyolefin polymer.

30. The film structure of claim 23 wherein said film structure comprises five layers.

31. The film structure of claim 23 wherein said film structure comprises seven layers.

32. The film structure of claim 23 wherein said film structure comprises nine layers.

33. The film structure of claim 1, said first layer further comprising at least one additive selected from the group consisting of color concentrates, neutralizers, process aids, lubricants, stabilizers, hydrocarbon resins, antistatics, slip agents, and antiblocking agents.

34. The film structure of claim 1, said second layer further comprising at least one additive selected from the group consisting of color concentrates, neutralizers, process aids, lubricants, stabilizers, hydrocarbon resins, antistatics, slip agents and antiblocking agents.

35. The film structure of claim 1, said third layer further comprising at least one additive selected from the group consisting of color concentrates, neutralizers, process aids, lubricants, stabilizers, hydrocarbon resins, antistatics, slip agents and antiblocking agents.

36. The film structure of claim 24, said layer further comprising at least one additive selected from the group consisting of color concentrates, neutralizers, process aids, lubricants, stabilizers, hydrocarbon resins, antistatics, slip agents and antiblocking agents.

37. The film structure of claim 27, said layer further comprising at least one additive selected from the group consisting of color concentrates, neutralizers, process aids, lubricants, stabilizers, hydrocarbon resins, antistatics, slip agents and antiblocking agents.

38. A film structure comprising:
a first layer comprising a quantity of at least one polyolefin polymer and a quantity of a cycloolefin polymer;
a second layer comprising a quantity of at least one polyolefin polymer and a quantity of a cycloolefin polymer; and
a third layer comprising a quantity of a metallocene-catalyzed polyolefin polymer.

39. The film structure of claim 38 wherein said first layer comprises from about 5-30% by weight of said film structure.

40. The film structure of claim 38 wherein said second layer comprises from about 5-30% by weight of said film structure.

41. The film structure of claim 39 wherein said first layer comprises about 15% by weight of said film structure.

42. The film structure of claim 40 wherein said second layer comprises about 15% by weight of said film structure.

43. The film structure of claim 42 wherein said third layer comprises from about 60-90% by weight of said film structure.

44. The film structure of claim 43 wherein said third layer comprises about 70% by weight of said film structure.

45. The film structure of claim 38 wherein said polyolefin polymer comprises from about 50-99% by weight of said first layer.

46. The film structure of claim 45 wherein said polyolefin polymer comprises about 75% by weight of said first layer.

47. The film structure of claim 38 wherein said polyolefin polymer comprises from about 60-90% by weight of said second layer.

48. The film structure of claim 47 wherein said polyolefin polymer comprises about 75% by weight of said second layer.

49. The film structure of claim 38 wherein said polymer comprises from about 1-100% by weight of said third layer.

50. The film structure of claim 49 wherein said polymer comprises from about 50-90% by weight of said third layer.

51. The film structure of claim 38 wherein said polyolefin polymer is selected from the group consisting of polyethylene, polypropylene, polybutenes, polyisoprene, copolymers thereof, terpolymers thereof, α-olefin propylene copolymers, and mixtures thereof.

52. The film structure of claim 51 wherein said polyolefin polymer is selected from the group consisting of linear low density polyethylene, low density polyethylene, ultra low density polyethylene, ethylene acetyl acetate, and mixtures thereof.

53. The film structure of claim 38 wherein said cycloolefin polymer is selected from the group consisting of cyclopentadiene, cyclohexadiene, cyclooctatetetraene, polynorbornene, polydimethyloctahydronaphthalene, cyclopentene, poly(5-methyl) norbornene, and mixtures thereof.

54. The film structure of claim 38 wherein said metallocene-catalyzed polyolefin polymer is metallocene linear low density polyethylene.

55. The film structure of claim 38 wherein said film structure has a thickness of up to 10 mils.

56. The film structure of claim 55 wherein said film structure has a thickness of from about 2.7-5.5 mils.

57. The film structure of claim 38 wherein said film structure is a blown film structure.

58. The film structure of claim 38 wherein said third layer is disposed between said first layer and said second layer.

59. The film structure of claim 58 further comprising a plurality of additional layers disposed between said first layer and said second layer.

60. The film structure of claim 59 wherein said additional layers comprises at least one layer comprising from about 70-100% by weight of a polyolefin polymer.

61. The film structure of claim 60 wherein said polyolefin polymer is selected from the group consisting of polyethylene, polypropylene, polybutenes, polyisoprene, copolymers thereof, terpolymers thereof, α-olefin propylene copolymers, and mixtures thereof.

62. The film structure of claim 61 wherein said polyolefin polymer is selected from the group consisting of linear low density polyethylene, low density polyethylene, ultra low density polyethylene, ethylene acetyl acetate, and mixtures thereof.

63. The film structure of claim 59 wherein said additional layers comprises at least one layer comprising a polyamide polymer.

64. The film structure of claim 59 wherein said film structure comprises five layers.

65. The film structure of claim 59 wherein said film structure comprises seven layers.

66. The film structure of claim 59 wherein said film structure comprises nine layers.

67. The film structure of claim 38, said first layer further comprising at least one additive selected from the group consisting of color concentrates, neutralizers, process aids, lubricants, stabilizers, hydrocarbon resins, antistatics, slip agents, and antiblocking agents.

68. The film structure of claim 38, said second layer further comprising at least one additive selected from the group consisting of color concentrates, neutralizers, process aids, lubricants, stabilizers, hydrocarbon resins, antistatics, slip agents and antiblocking agents.

69. The film structure of claim 38, said third layer further comprising at least one additive selected from the group consisting of color concentrates, neutralizers, process aids, lubricants, stabilizers, hydrocarbon resins, antistatics, slip agents and antiblocking agents.

70. The film structure of claim 60, said layer further comprising at least one additive selected from the group consisting of color concentrates, neutralizers, process aids, lubricants, stabilizers, hydrocarbon resins, antistatics, slip agents and antiblocking agents.

71. The film structure of claim 63, said layer further comprising at least one additive selected from the group consisting of color concentrates, neutralizers, process aids, lubricants, stabilizers, hydrocarbon resins, antistatics, slip agents and antiblocking agents.
